(19) United States
(12) Patent Application Publication
(10) Pub. No.: US 2019/0283948 A1
(43) Pub. Date: Sep. 19, 2019

(54) TRAY FOR PACKAGING FOOD PRODUCTS CONSTITUTED OF A FLAT SHEET OF MULTI-LAYER MATERIAL AND PACK COMPRISING SUCH TRAY

(71) Applicant: G.MONDINI S.P.A., I-25033 Cologne (Brescia) (IT)

(72) Inventor: GIOVANNI MONDINI, COLOGNE (IT)

(21) Appl. No.: 16/353,731

(22) Filed: Mar. 14, 2019

(30) Foreign Application Priority Data
Mar. 19, 2018 (IT) 102018000003743

(51) Int. Cl. B65D 75/58; B32B 7/06; B65D 1/34

(52) U.S. Cl. CPC B65D 75/5838; B32B 7/06; B65D 77/2048; B32B 2439/70; B65D 1/34

(57) ABSTRACT

A pack comprising a tray (1) constituted of a flat sheet of multi-layer material, with one paper-based lower layer and one plastic material upper layer, which has a perimetric edge (2), and an elongate cut (3) that extends near the perimetric edge (2) and is spaced from it, wherein between the elongate cut (3) and the perimetric edge (2) a portion of the flat sheet is identified which defines a frame (5) that at least partly surrounds an inner part (6) of the flat sheet on which a food product is positioned; at least one protective film (12) fixed to the tray (1) at both a first connecting zone (13) that extends continuously on the inner part (6) of the flat sheet in a closed ring that surrounds the food product, and at a second connecting zone (14) that extends at least along the frame (5) and externally relative to the first connecting zone (13).

This invention relates to a tray for packaging food products constituted of a flat sheet of multi-layer material as well as a pack which comprises that tray. For some years now a packaging technology has been known on the market, invented by the same Applicant, and marketed under the Slimfresh® trademark, in which food products are packaged in packs constituted of only two elements, both flat (before packaging): a lower tray constituted of a flat sheet of multi-layer material, and an upper protective film.

The tray usually has a rectangular shape with rounded corners, and the flat sheet comprises a paper-based lower layer and a plastic material upper layer.

The protective film is sealed to the upper layer of the tray along a ring-shaped connecting zone which surrounds the food product.

This aim of this invention is to improve on this technology which, despite many advantages, also has some disadvantages if the user does not consume the entire food product in one go, but instead wants to preserve a part for later. In fact, the simplicity of the pack makes it relatively difficult to preserve the products contained in it in the best possible way between one use and the next, above all to protect them from the ambient air, therefore it may be necessary either to transfer the remaining food product to a different container or to cover the entire container with a protective film.

In this context the technical purpose which forms the basis of this invention is to provide a tray for packaging food products constituted of a flat sheet of multi-layer material, and a pack which comprises that tray, which overcome the above-mentioned disadvantages.

In particular, the technical purpose of this invention it to provide a tray for packaging food products, constituted of a flat sheet of multi-layer material, which allows a pack to be made, the pack making it possible to preserve part of the food product for later in a better way than is possible with the packs of this type already on sale.

A further technical purpose of this invention is to provide a tray for packaging food products constituted of a flat sheet of multi-layer material, which allows a pack to be made which is easy to use for the consumer.

The technical purpose and the aims indicated are substantially achieved by a tray for packaging food products constituted of a flat sheet of multi-layer material, and by a pack which comprises that tray, as described in the appended claims.

Further features and the advantages of this invention are more apparent in the detailed description, with reference to the accompanying drawings which illustrate several preferred, non-limiting embodiments of a tray for packaging food products constituted of a flat sheet of multi-layer material, and a pack which comprises that tray, in which:

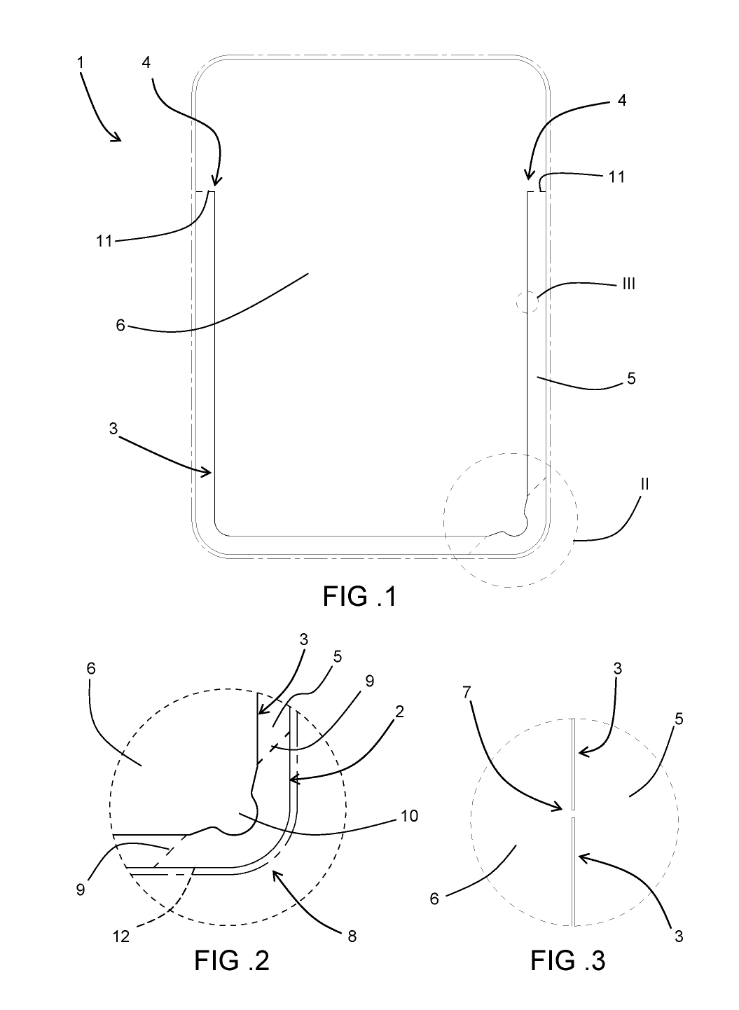

FIG. 1 shows, in plan view, a tray made according to this invention, with a long dash and short dash line highlighting a protective film couplable to the tray;

FIG. 2 is an enlarged view of the detail II of FIG. 1;

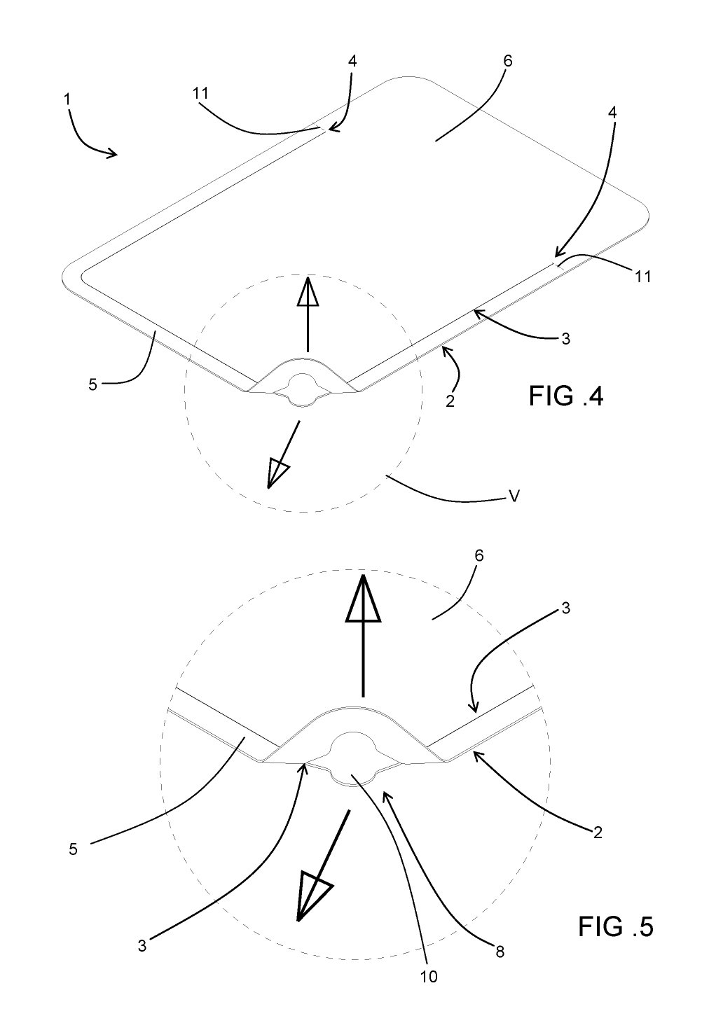

FIG. 3 is an enlarged view of the detail III of FIG. 1;

FIG. 4 is an axonometric view of the tray of FIG. 1 with one part bent;

FIG. 5 is an enlarged view of the detail V of FIG. 4;

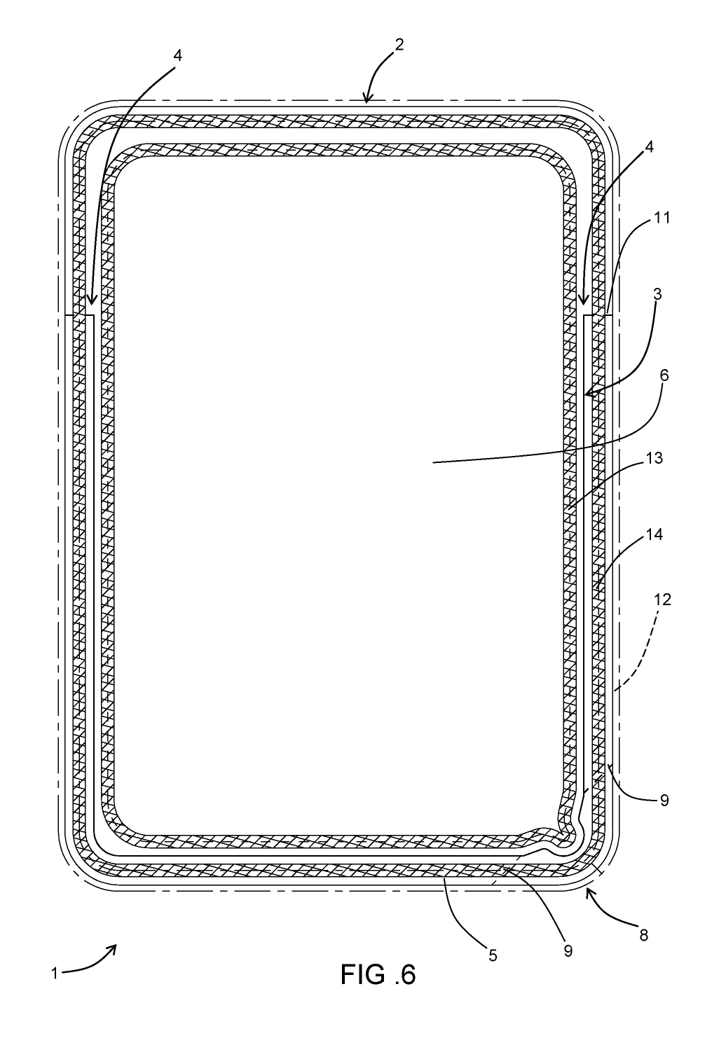

FIG. 6 shows the tray of FIG. 1 highlighting zones for connecting to the protective film;

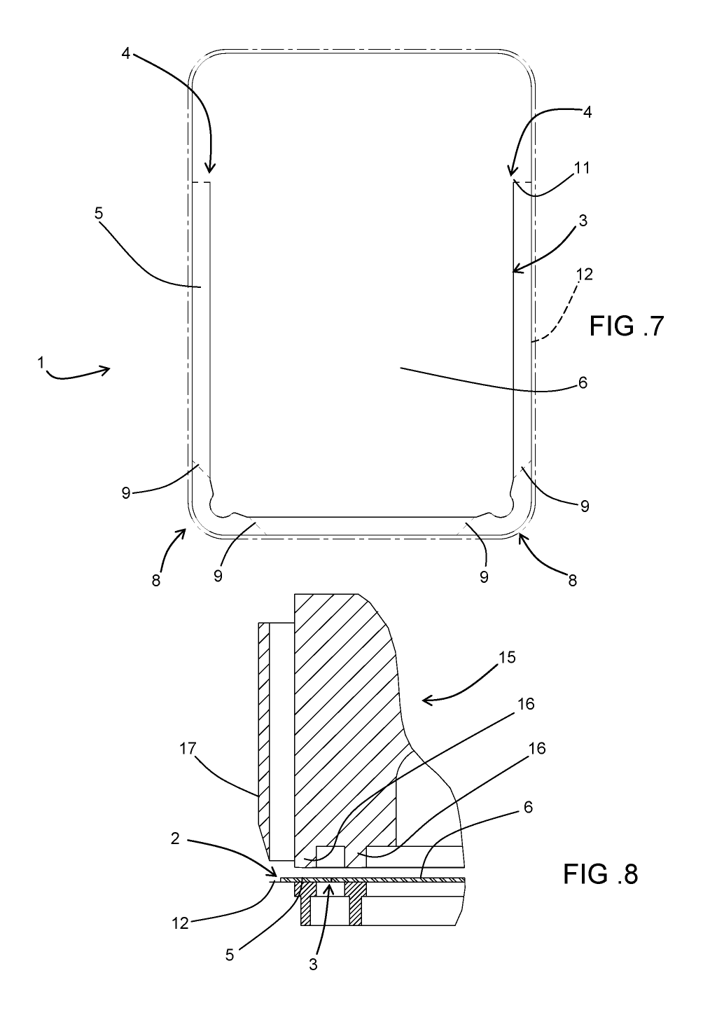

FIG. 7 shows an alternative embodiment of the tray of FIG. 1; and

FIG. 8 is a side view in cross-section of an example of a sealing machine usable for constraining a protective film to the tray.

With reference to the above-mentioned figures the numeral 1 denotes in its entirety a tray for packaging food products according to this invention.

As already indicated, the tray 1 is constituted of a single flat sheet of multi-layer material which comprises at least one paper-based lower layer and one plastic material upper layer (which are not highlighted in the accompanying figures), and which has a perimetric edge 2. Optionally, there may also be further, intermediate layers.

Advantageously, the upper layer may be made of material transparent to visible light and the paper-based layer may be printed with various types of images and/or information.

In terms of shape, the flat sheet may adopt the shape best suited to the requirements. In the preferred embodiment illustrated in the accompanying figures it has a substantially rectangular shape with rounded corners. However, other shapes are possible (for example, oval, circular, square, rhomboid, etc.).

According to this invention, the tray 1 has an elongate cut 3 that extends near the perimetric edge 2 but remains spaced from it along its entire length.

In the embodiments illustrated, the elongate cut 3 extends in particular between two ends 4 which are separate and spaced from one another and it advantageously extends for most of the extent of the perimetric edge 2 (that is to say, along more than half of the extent of the perimetric edge 2) but not along the entire perimetric edge 2.

The elongate cut 3 is shaped in such a way that between it and the perimetric edge 2 a portion of the flat sheet remains identified which defines a frame 5 that at least partly surrounds an inner part 6 of the flat sheet, the inner part 6 on which, in use, a food product is to be positioned. That result may be obtained by shaping the elongate cut 3 in such a way that it forms a concavity on the side facing the inner part 6 and a convexity on the side facing the outside of the tray 1.

Advantageously, in the preferred embodiments both the elongate cut 3 and the frame 5, in plan view, overall are U-shaped or C-shaped.

Preferably, in order to give the tray 1 stability at least before its use to make a pack, it is possible to ensure that there are one or more connecting points 7 present between the frame 5 and the inner part 6 of the flat sheet, at which the elongate cut 3 is interrupted for a short stretch (FIG. 3). Those connecting points 7 are advantageously obtained by making the elongate cut 3 in stretches, with each stretch separated from the next by a connecting point 7, so that each connecting point is a sort of “protuberance” left while performing the cut. In any case, they are made in such a way as to constitute facilitated breaking zones, and for that purpose they have a length (measured as the distance between the two adjacent stretches of the elongate cut 3) which is small, usually around 1 mm or less.

In other embodiments which in any case comprise the presence of connecting points 7, suitable for keeping the frame 5 attached to the inner part 6 in the absence of external stresses, it may even be the case that both the elongate cut 3 and the frame 5 completely surround the inner part 6 of the flat sheet, that is to say, that the frame 5 is a single whole ring positioned around the inner part 6 and only connected to the inner part by the connecting points 7 (solution not illustrated).

According to a second innovative aspect of this invention, the frame 5 has at least one opening portion 8, intended to facilitate the opening of a pack which comprises the tray 1 according to this invention, as described in more detail below.

The opening portion 8 corresponds to a stretch of the frame 5 which is delimited, on two opposite sides, by two main preferential bending lines 9 which are made in the frame 5, and on the other two sides, respectively by the perimetric edge 2 and by the elongate cut 3 (however, the later side may not be present if the main preferential bending lines 9 meet at a single point of the elongate cut 3).

Each main preferential bending line 9 extends from the perimetric edge 2 to the elongate cut 3 and is advantageously constituted of a localized crushing of the flat sheet. Together, the two main preferential bending lines 9 allow bending of the opening portion 8 of the frame 5 relative to the rest of the flat sheet (FIGS. 4 and 5). Moreover, in order to facilitate the achievement of that result, the main preferential bending lines 9 are advantageously straight, and aligned with one another in such a way that one constitutes a continuation of the other along the same straight line.

With reference to a straight line which passes through the points at which the two main preferential bending lines 9 intersect the elongate cut 3, in the preferred embodiment the elongate cut 3 extends in such a way as to define a projection 10 of the inner part 6 of the flat sheet, which protrudes towards the perimetric edge 2, going beyond that straight line. In this way, when the opening portion 8 of the frame 5 is bent upwards (FIG. 5) it is possible to use the protruding projection 10 to hold the inner part 6 of the flat sheet while opening the pack (this point will be described in more detail below).

In the preferred embodiments, the opening portion 8 is made at a linking zone between two further portions of the frame 5 which extend mainly along lines that are at an angle or perpendicular to each other. For example, the opening portion 8 may be made at the main corners of the flat sheet (FIG. 1).

Even if in general one opening portion 8 may be sufficient, there are also embodiments in which the frame 5 has a plurality of opening portions 8, such as that in FIG. 7.

In the preferred embodiment, in which the cut has two ends 4 which are separate and spaced from one another, it is also the case that the flat sheet has two secondary preferential bending lines 11, which each extend between one end 4 of the elongate cut 3 and the perimetric edge 2, and which have the function of allowing, in use, a bending of the whole frame 5 relative to the rest of the flat sheet. Advantageously, the secondary preferential bending lines 11 are also straight, and aligned with one another in such a way that one constitutes a continuation of the other along the same straight line.

As already indicated, this invention also relates a pack which uses the tray 1 described above together with a protective film 12 fixed to it, for containing a food product.

In this case, the food product will be positioned on the inner part 6 of the flat sheet and there will also be at least two separate connecting zones 13, 14 between the protective film 12 and the tray 1, a first connecting zone 13 that extends continuously on the inner part 6 of the flat sheet in a closed ring that surrounds the food product (that is to say, inside the frame 5), and a second connecting zone 14 that extends along the frame 5 externally relative to the first connecting zone 13. Advantageously, the second connecting zone 14 also extends continuously in a closed ring, which may be either external relative to the closed ring along which the first connecting zone 13 extends (FIG. 6), or partly overlapping it (in the case in FIG. 6, for example, the two connecting zones 13, 14 could overlap at the top part).

The first connecting zone 13 does not affect the protruding projection 10 defined by the elongate cut 3 which is therefore detached from the protective film 12.

Therefore, advantageously, the pack is made in such a way that it is reclosable, that is to say, in such a way that it can be partly closed again after the protective film 12 has been detached from the tray 1 at least at one part of the first connecting zone 13. In other words, at least at the first connecting zone 13 the protective film 12 is connected to the tray 1 in such a way that it can be detached and stuck down again (technical solution in itself known and therefore not described in detail).

FIG. 8 shows a schematic example of a detail of a sealing machine 15 capable of simultaneously making the protective film 12 stick to the tray 1 at two connecting zones 13, 14 which are near but spaced from one another; for that purpose the machine has two sealing bodies 16 which are near but spaced from one another. The machine also has a blade 17 suitable for cutting a piece of protective film 12 from a continuous web.

Use of the pack described above is very simple.

In order to open it, the user first uses his or her fingers to grip the opening portion 8 of the frame 5 and the protective film 12 connected to it and bends them upwards relative to the rest of the flat sheet (as in FIG. 5). At this point, if the protruding projection 10 is present, with his or her other hand the user can grip the protruding projection 10 which has been freed below the portion of protective film 12 which has been bent upwards. Firmly holding the opening portion 8 and the protective film 12 fixed to it with one hand, and the protruding projection 10 with the other hand, the user can then apply the force necessary to gradually cause both bending of the whole frame 5 upwards, and separation of the protective film 12 from the tray 1 at the first connecting zone 13.

Once the pack has been opened enough to gain access to the food product, the user can take out the quantity of it that is required. If not all of the food product is used, with an inverse movement relative to that described, the user can return the frame 5 to the same plane as the rest of flat sheet, then simply apply gentle pressure on the protective film 12 at the first connecting zone 13 so as to stick down the protective film 12 on the tray 1 again, sufficiently reclosing the pack for guaranteeing good preservation of the food product.

This invention brings important advantages.

Thanks to this invention it has been possible to make a tray of the type constituted of a flat sheet of multi-layer material which allows a pack to be made with which, compared to the prior art trays, it is possible to obtain better preservation of the food products between two uses at different times. The tray according to this invention also allows a pack to be made which is extremely easy to use.

Finally, it should be noticed that this invention is relatively easy to produce and that even the cost linked to implementing the invention is not very high.

The invention described above may be modified and adapted in several ways without thereby departing from the scope of the inventive concept.

All details may be substituted with other technically equivalent elements and the materials used, as well as the shapes and dimensions of the various components, may vary according to requirements.

1. A tray for packaging food products constituted of a flat sheet of multi-layer material, wherein:
the flat sheet comprises at least one paper-based lower layer and one plastic material upper layer and has a perimetric edge (2);
the tray (1) has an elongate cut (3) that extends near the perimetric edge (2) and spaced from it;
between the elongate cut (3) and the perimetric edge (2) a portion of the flat sheet is identified which defines a frame (5) that at least partly surrounds an inner part (6) of the flat sheet on which, in use, a food product is to be positioned;
the frame (5) has at least one opening portion (8), delimited on two opposite sides by two main preferential bending lines (9) which are made in the frame (5);
each main bending line extends from the perimetric edge (2) to the elongate cut (3);
the main preferential bending lines (9) allow a bending of the opening portion (8) of the frame (5) relative to the rest of the flat sheet;
and wherein at the opening portion (8) of the frame (5), the elongate cut (3) delimits a protruding projection (10) of the inner part (6) of the flat sheet, which protrudes towards the perimetric edge (2), relative to a straight line that passes through two points at which the two main preferential bending lines (9) intersect the elongate cut (3).

2. The tray according to claim 1, wherein the two main preferential bending lines (9) extend along the same straight line.

3. The tray according to claim 1, wherein the opening portion (8) is made at a linking zone between two further portions of the frame (5) which extend mainly along lines that are at an angle or perpendicular to each other.

4. The tray according to claim 1, wherein the frame (5) has a plurality of opening portions (8).

5. The tray according to claim 1, wherein the elongate cut (3) extends for most of the extent of the perimetric edge (2).

6. The tray according to claim 1, wherein the elongate cut (3) and the frame (5), in plan view, are each overall U-shaped or C-shaped.

7. The tray according to claim 1, wherein the flat sheet also has two secondary preferential bending lines (11), which each extend between one end (4) of the elongate cut (3) and the perimetric edge (2), for allowing, in use, a bending of the whole frame (5) relative to the rest of the flat sheet.

8. The tray according to claim 1, wherein there are one or more connecting points (7) present between the frame (5) and the inner part (6) of the flat sheet, at which the elongate cut (3) is interrupted, said connecting points (7) constituting facilitated breaking zones.

9. A pack containing at least one food product comprising:
a tray (1) constituted of a flat sheet of multi-layer material, wherein the flat sheet comprises at least one paper-based lower layer and one plastic material upper layer and has a perimetric edge (2), wherein the tray (1) has an elongate cut (3) that extends near the perimetric edge (2) and spaced from it, and wherein between the elongate cut (3) and the perimetric edge (2) a portion of the flat sheet is identified which defines a frame (5) that at least partly surrounds an inner part (6) of the flat sheet;
a food product positioned on the inner part (6) of the flat sheet; and
at least one protective film (12) fixed to the tray (1);
wherein there are also at least two connecting zones (13), (14) that are at least partly separate, between the protective film (12) and the tray (1), a first connecting zone (13) that extends continuously on the inner part (6) of the flat sheet in a closed ring that surrounds the food product, and a second connecting zone (14) that extends at least along the frame (5) and externally relative to the first connecting zone (13).

10. The pack according to claim 9, wherein the pack is reclosable and wherein, at the first connecting zone (13), the protective film (12) is fixed to the tray (1) in such a way that it can be detached and stuck down again.

11. The pack according to claim 9, wherein the second connecting zone (14) also extends continuously in a closed ring.

12. The pack according to claim 9, wherein the frame (5) has at least one opening portion (8), delimited on two opposite sides by two main preferential bending lines (9) which are made in the frame (5), wherein each main bending line extends from the perimetric edge (2) to the elongate cut (3), and wherein the main preferential bending lines (9) allow a bending of the opening portion (8) of the frame (5) relative to the rest of the flat sheet.

13. The pack according to claim 12, wherein at the opening portion (8) of the frame (5), the elongate cut (3) delimits a protruding projection (10) of the inner part (6) of the flat sheet, which protrudes towards the perimetric edge (2), relative to a straight line that passes through two points at which the two main preferential bending lines (9) intersect the elongate cut (3).

14. The pack according to claim 12, wherein the two main preferential bending lines (9) extend along the same straight line.

15. The pack according to claim 12, wherein the opening portion (8) is made at a linking zone between two further portions of the frame (5) which extend mainly along lines that are at an angle or perpendicular to each other.

16. The pack according to claim 12, wherein the frame (5) has a plurality of opening portions (8).

17. The pack according to claim 9, wherein the elongate cut (3) extends for most of the extent of the perimetric edge (2).

18. The pack according to claim 9, wherein the elongate cut (3) and the frame (5), in plan view, are each overall U-shaped or C-shaped.

19. The pack according to claim 9, wherein the flat sheet also has two secondary preferential bending lines (11), which each extend between one end (4) of the elongate cut (3) and the perimetric edge (2), for allowing, in use, a bending of the whole frame (5) relative to the rest of the flat sheet.

20. The pack according to claim 9, wherein there are one or more connecting points (7) present between the frame (5) and the inner part (6) of the flat sheet, at which the elongate cut (3) is interrupted, said connecting points (7) constituting facilitated breaking zones.
